(19) United States
(12) Patent Application Publication
(10) Pub. No.: US 2026/0249532 A1
(43) Pub. Date: Aug. 27, 2026

(54) AN INJECTION MOLDING MACHINE

(71) Applicant: LEGO A/S, Billund (DK)

(72) Inventors: Hans-Jørn Terp KRISTENSEN, Billund (DK); Jens Stamp LAMBÆK, Billund (DK)

(73) Assignee: LEGO A/S, Billund (DK)

(21) Appl. No.: 18/856,770

(22) PCT Filed: Apr. 21, 2023
(86) PCT No.: PCT/EP2023/060380

§ 371 Date: Oct. 14, 2024

(30) Foreign Application Priority Data
Apr. 28, 2022 (DK) PA202270225

(51) Int. Cl. B29C 45/23; B29C 45/20; B29C 45/27

(52) U.S. Cl. CPC B29C 45/232; B29C 45/2735; B29C 2045/207; B29C 2045/235; B29C 2045/238

(57) ABSTRACT

An injection molding machine configured for automated molding of work pieces in plastics. The injection molding machine has a mold and an injection barrel with an outlet. The injection molding machine also has an injection nozzle with a nozzle tip forming a distal end of the injection nozzle. The injection nozzle has an injection channel extending along a longitudinal axis from a proximal end of the injection nozzle fastened to the barrel and to a nozzle gate opening arranged at the nozzle tip. The injection molding machine also has a valve member slidably connected to the nozzle tip to slide along the longitudinal axis between a first position closest to the proximal end and a second position farther away from the proximal end, and so that the nozzle gate opening is closed by the valve member in the second position and open in the first position.

### CROSS-REFERENCE TO RELATED APPLICATIONS

The present application is a U.S. National Stage Application of International Application No. PCT/EP2023/060380 filed on Apr. 21, 2023, published on Nov. 2, 2023 as WO2023/208749, and entitled AN INJECTION MOLDING MACHINE, which claims the benefit and priority of Danish Patent Application No. PA202270225, filed on Apr. 28, 2022, each of which is incorporated herein by reference in its entirety for any purpose whatsoever.

### FIELD OF THE DISCLOSURE

The present disclosure relates to the field of injection molding using an injection molding machine configured for automated molding of work pieces in plastics, said injection-molding tool comprising a mold and an injection barrel with an outlet and where the injection molding machine further comprises an injection nozzle with a nozzle tip forming a distal end of the injection nozzle, and where the injection nozzle have an injection channel adapted for leading fluid plastic material from the barrel to the mold and extending along a longitudinal axis from a proximal end of the injection nozzle fastened to the barrel and to a nozzle gate opening arranged at the nozzle.

### BACKGROUND

In relation to injection molding machines of this type, and especially injection molding machines operating with molds of the cold runner type the injection nozzle may be equipped with a valve construction in order to block the flow of plastic material through the injection nozzle between each molding cycle, and for this purpose different embodiments of injection nozzles with anti drooling valves have been disclosed in the prior art.

Examples of injection molding machines equipped with such anti drooling injection nozzles are known from DE patent no. 689328 C, U.S. Pat. No. 3,354,507 A and CN patent application no. 106182603 A.

### SUMMARY

Based on this, it is the object of the present disclosure to provide an injection molding machine having an injection nozzle with an anti-drooling valve with a simple but yet very reliable construction.

According to the disclosure this is obtained by providing the injection nozzle with a valve member slidably arranged with respect to the nozzle tip so that it can move between a first position closest to the proximal end and a second position farther away from the proximal end, and so that the valve member closely covers the nozzle gate opening in its second position and leaves the nozzle gate open in its first position.

Thereby all plastic material outside the injection nozzle and downstream from the nozzle gate opening after each molding cycle is efficiently cut or stripped away from the injection nozzle by the valve member.

Furthermore, it is possible to design the nozzle gate without necessarily providing the nozzle gate with a locally reduced cross section for forming a cold plug of material in order to reduce drooling of material from the nozzle gate between two production cycles

In a preferred embodiment of the disclosure, the nozzle gate opening is arranged in an outer surface of the nozzle tip and the outer surface extend parallel with the longitudinal axis and the valve member is arranged so that it can slide on the outer surface.

In an especially simple and reliable construction the nozzle tip and the outer surface of the nozzle tip forms an axle tap and the valve member is formed by a bushing that can slide on the outer surface.

The outer surface may preferably in this relation be circular cylindrical and the bushing may have a circular cylindrical inner surface snugly surrounding the outer surface.

The nozzle tip may in some embodiments of the disclosure comprise two or more nozzle gates arranged at the same position along the longitudinal axis.

In this relation, the nozzle gates may furthermore be distributed equidistantly on different sides of the nozzle tip.

In a preferred embodiment providing that, the injection nozzle can easily be adapted to different mold constructions the nozzle tip is a separate component being releasably attached to the remaining part of the injection nozzle comprising the proximal end of the injection nozzle.

In an especially advantageous embodiment of the disclosure the injection molding machine further comprises a first movable mold plate and at least one guide element adapted for allowing the first movable mold plate to move in a direction parallel with the longitudinal axis, and where the first movable mold plate comprises the valve member and the injection molding machine comprises an actuator adapted for moving the first movable mold plate and the valve member between the first and the second position.

The injection machine may in this relation further comprise a second movable mold plate and at least one guide element adapted for allowing the second movable mold plate to move in a direction parallel with the longitudinal axis between a closed position where adjacent sides of the first and the second movable mold plates are abutting each other and forming substantially closed mold cavities between them and an open position where the first and the second movable mold plates are away from each other, and where the valve member is in its first position when the first and the second movable mold plates are in the open position and the first and the second movable mold plates are in the closed position when the valve member is in its second position.

In this relation, the mold is preferably a cold runner type mold, and the cavities between the first and the second movable mold plates forms cold runner channels.

### BRIEF DESCRIPTION OF THE DRAWINGS

It should be appreciated that the subject technology can be implemented and utilized in numerous ways, including without limitation as a process, an apparatus, a system, a device, a method for applications now known and later developed. So that those having ordinary skill in the art to which the disclosed technology appertains will more readily understand how to make and use the same, reference may be had to the following drawings.

FIG. 1 is a principle drawing showing a cross section through a part of an injection molding apparatus according one embodiment of the disclosure in one position.

FIG. 2 is a principle drawing showing the embodiment of the disclosure as shown in FIG. 1 in another position.

FIG. 3 is a perspective drawing showing a detail of the embodiment according to FIGS. 1 and 2 from one side.

FIGS. 4, 5 and 6 show alternative embodiments of nozzle tip shown in FIGS. 1, 2 and 3.

### DETAILED DESCRIPTION

The subject technology overcomes many of the prior art problems associated with injection molding machines. The advantages, and other features of the technology disclosed herein, will become more readily apparent to those having ordinary skill in the art from the following detailed description of certain preferred embodiments taken in conjunction with the drawings which set forth representative embodiments of the present technology and wherein like reference numerals identify similar structural elements. Directional indications such as front, back, upward, downward, right, left and the like are used with respect to the figures and not meant in a limiting manner.

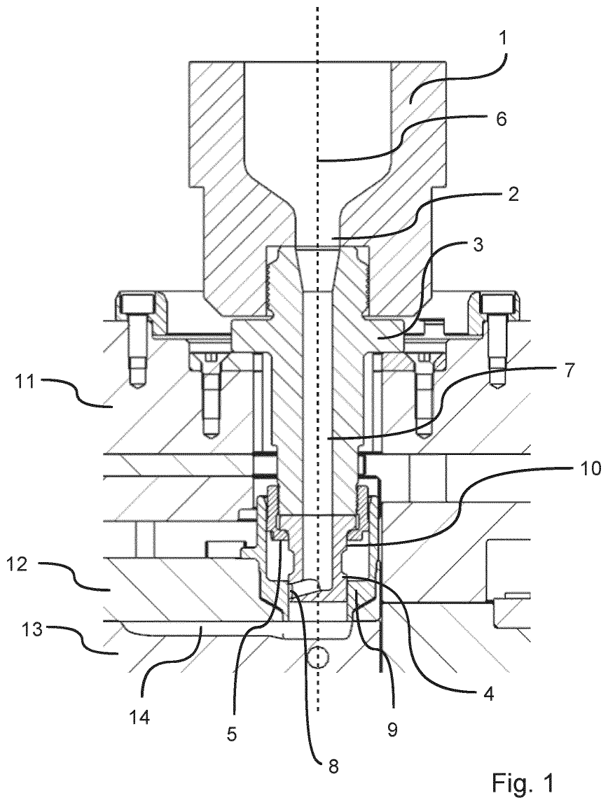

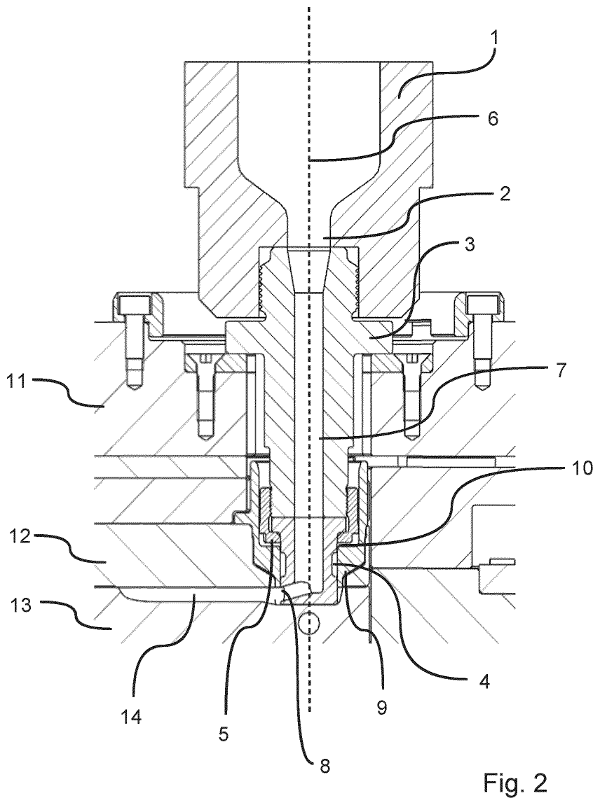

FIGS. 1 and 2 show a part of an injection molding machine configured for automated molding of work pieces in plastics. However, the present disclosure is applicable to any type of machinery adapted for injection molding. Only the parts necessary for illustrating the principle of the disclosure is shown in the drawing.

The injection molding machine comprises an injection barrel 1 with an outlet 2 where an injection nozzle 3 with a nozzle tip 4 is arranged. In this embodiment the nozzle tip 4 is attached to the injection nozzle 3 with a swivel nut 5 so that it forms the distal end of the injection nozzle 3, but in other embodiments the nozzle may e.g. be screwed directly into the injection nozzle 3 or even be produced as an integral part of the injection nozzle 3. The injection nozzle 3 and the nozzle tip have an injection channel 7 that extend along a longitudinal axis 6 from a proximal end of the injection nozzle 3 and to a nozzle gate opening 8 arranged at the nozzle tip 4.

The injection molding machine further comprises a valve member 9 slidably arranged with respect to the nozzle tip 4 so that it can move between a first position closest to the proximal end such as shown in FIG. 2 and a second position farther away from the proximal end as shown in FIG. 1, and so that the valve member 9 closely covers the nozzle gate opening 8 in its second position and leaves the nozzle gate 8 open in its first position.

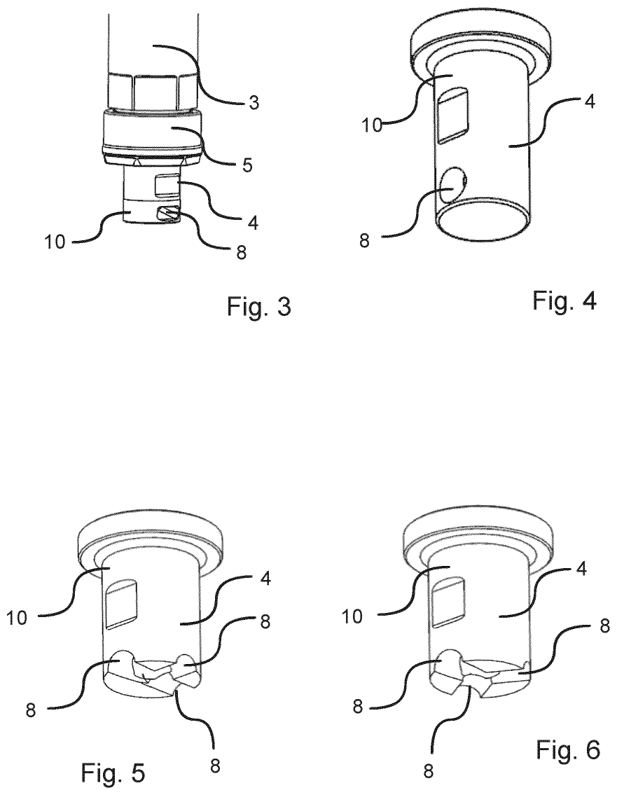

In this embodiment as shown in more detail in FIG. 3 the nozzle tip 4 forming the distal end of the injection nozzle 3 have a circular cylindrical outer surface 10 that forms an axle tap and the valve member 9 is a substantially circular cylindrical bushing that can slide on the outer surface 10 and snugly surrounds the outer surface 10 so that it provides an tight closure of the nozzle gate in its second position as shown in FIG. 2 and provides that the flow of plastic material from the nozzle tip 4 is free to flow through the injection nozzle when the bushing is mowed from its second position as shown in FIG. 1 an into its first position.

According to this principle, the valve member 9 provides an efficient anti drooling function using only few components that are easy to assemble, clean and dismantle. Furthermore, it provides that a sprue can be avoided in the mold as the distal end of the injection nozzle 3 and the nozzle tip 4 can easily extend a distance into a conventional injection mold comprising a number of mold plates. In the embodiment shown in FIGS. 1 and 2, illustrated is a set of mold plates comprising a stationary mold plate 11 and a first movable mold plate 12. The stationary mold plate 11 is mounted in a fixed position along the longitudinal axis 6 with respect to the injection barrel 1 and thereby the injection nozzle 3 and the nozzle tip 4.

The first movable mold plate 12 is adapted to move along the longitudinal axis 6 and the valve member 9 is attached to the first movable mold plate 12 so that the first movable mold plate moves the valve member 9 between the open and the closed position. In this embodiment, the injection molding machine further comprises an actuator (not shown) adapted for moving the first movable mold plate and thereby the valve member between the first and the second position.

In FIGS. 1 and 2, the injection machine further comprises a second movable mold plate 13 being adapted to move along the longitudinal axis between a closed position where adjacent sides of the first and the second movable mold plates 12, 13 are abutting each other and forming substantially closed mold cavities between them and an open position where the first and the second movable mold plates are away from each other (not shown), and where the valve member 9 is in its first position when the first and the second movable mold plates 12, 13 are moved into their open position and the first and the second movable mold plates are in the closed position when the valve member is in its second position.

In this regard, the first and the second movable mold plates 12, 13 form runner channels 14 when the mold plates are in their closed position and the first movable mold plate 12, together with the valve member 9 strips off the molded runner (not shown) when the first and the second movable mold plates 12, 13 are in their open position.

Although this embodiment provides a very simple construction for controlling the position of the valve member 9, it will be apparent to the skilled person that the movement of the valve member 9 may alternatively be implemented using alternative or separate mechanisms and/or actuators being controlled independently.

Further in FIGS. 1, 2 and 3, the nozzle tip 4 have only a single nozzle gate opening 8 with a substantially rectangular cross section.

It will, however, be evident to the skilled person that nozzle tips having a different design than the one shown in FIGS. 1, 2 and 3 may be used for different runner channel designs or purposes. For example, FIGS. 4, 5 and 6 show alternative embodiments of the nozzle tip 4. Where the single nozzle gate opening 8 in figure is a circular cylindrical channel, and the nozzle tips shown in FIGS. 5 and 6 (where the most distal part of the nozzle tips are removed in order to show all nozzle gate openings 8) both have three nozzle gate openings 8. In FIG. 5, the spacing between the nozzle gate opening are different and in FIG. 6 the spacing between each pair of adjacent nozzle gate openings 8 are equal. The number of nozzles gate openings may, however, be more than 3 in cases where e.g. the runner system is more complex, and the spacing may also be different between the individual nozzle gate openings.

It will be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiment. Also, functional elements shown as distinct or integral for purposes of illustration may be incorporated within other functional elements or separated into multiple components in a particular implementation. Further, although the subject technology has been described with respect to injection molding, it is envisioned that the subject technology would be equally applicable to other devices.

While the subject technology has been described with respect to preferred embodiments, those skilled in the art will readily appreciate that various changes and/or modifications can be made to the subject technology and claims without departing from the spirit or scope of the disclosure. For example, each claim may depend from any or all claims in a multiple dependent manner even though such has not been originally claimed and various components and features may be added into other claims or removed from the original claims. Reference numerals in the claims are only for illustration and not limiting with respect to other embodiments, structures and versions.

1. An injection molding machine configured for automated molding of work pieces in plastics, the injection molding machine comprising a mold comprising a first and a second mold plate and an injection barrel with an outlet and where the injection molding machine further comprises an injection nozzle with a nozzle tip forming a distal end of the injection nozzle, and where the injection nozzle extend through the first mold plate and have an injection channel extending along a longitudinal axis from a proximal end of the injection nozzle fastened to the barrel and to a nozzle gate opening arranged at the nozzle tip, and the first and the second mold plates are adapted for being moved in a direction parallel with the longitudinal axis between a closed position where adjacent sides of the first and the second movable mold plates are abutting each other and forming a substantially closed mold cavity or a cold runner channel between them and an open position and wherein the injection molding machine comprises a valve member slidably connected to the nozzle tip to slide along the longitudinal axis between a first position closest to the proximal end and a second position farther away from the proximal end, and so that the nozzle gate opening is closed by the valve member in the second position and open in its-the first position.

2. The injection molding machine according to claim 1, wherein the nozzle gate opening is arranged in an outer surface of the nozzle tip, the outer surface extending parallel with the longitudinal axis, and wherein the valve member is attached to or forms an integral part of the first mold plate so that the valve member it is forced to slide on the outer surface simultaneously with the first mold plate.

3. The injection molding machine according to claim 2, wherein the outer surface is circular cylindrical, and the valve member is formed by a bushing having a circular cylindrical inner surface snugly surrounding the outer surface.

4. The injection molding machine according to claim 3, wherein the nozzle tip comprises two or more nozzle gates arranged at a same position along the longitudinal axis.

5. The injection molding machine according to claim 4, wherein the nozzle gates are distributed equidistantly on different sides of the nozzle tip.

6. The injection molding machine according to claim 1, wherein the nozzle tip is a separate component being releasably attached to the proximal end of the injection nozzle.

7. An injection molding machine comprising:
a first and second mold plate configured for axial movement between:
a closed position where adjacent sides of the first and the second mold plates are abutting each other, forming a substantially closed mold cavity; and
an open position where the adjacent sides of the first and the second mold plates are separated;
an injection channel for receiving injection molding material at an injection barrel thereof, the injection channel in communication with an injection nozzle opposite the injection barrel along the length of the injection channel, the injection nozzle terminating at a nozzle gate, the nozzle gate in communication with the mold cavity formed by the first and second mold plate; and
a valve member slidably arranged with respect to an outer surface of the injection nozzle, the valve member configured to slide and close the nozzle gate from communication with the mold cavity.

8. The injection molding machine according to claim 7, wherein the injection channel propagates through the first mold plate.

9. The injection molding machine according to claim 8, wherein the valve member is attached to or forms an integral part of the first mold plate so that the valve member slides on the outer surface of the injection channel, closing and opening the nozzle gate simultaneously with the movement of the first mold plate between the open and closed positions of the mold plates.

10. The injection molding machine according to claim 7, wherein the outer surface of the injection channel is circular cylindrical, and the valve member is a bushing having a circular cylindrical inner surface snugly surrounding the outer surface of the injection channel.

11. The injection molding machine according to claim 7, wherein the injection channel propagates through both the first mold plate and second mold plate.

12. An injection molding machine comprising:
a first and second mold plate, at least one of the first and second mold plates configured for axial movement toward the other of the first and second mold plates, wherein:
in a closed position, adjacent sides of the first and the second mold plates are abutting each other, forming a substantially closed mold cavity or channel; and
in an open position, the adjacent sides of the first and the second mold plates are separated;
an injection channel for receiving injection molding material, the injection channel in communication with a nozzle gate; and
a valve member, wherein:
in a closed position, the valve member axially slides around the nozzle gate to radially cover the nozzle gate and prevent injection molding material from dispensing therefrom; and
in an open position, the valve member axially slides away from the nozzle gate enabling the nozzle gate to be in communication with the mold cavity or channel formed by the first and second mold plate.

13. The injection molding machine according to claim 12, wherein the injection channel propagates through the first mold plate.

14. The injection molding machine according to claim 13, wherein the valve member is attached to or forms an integral part of the first mold plate so that the valve member slides on an outer surface of the injection channel, closing and opening the nozzle gate simultaneously with the movement of the first mold plate between the open and closed positions of the mold plates.

15. The injection molding machine according to claim 12, wherein an outer surface of the injection channel is circular cylindrical, and the valve member is a bushing having a circular cylindrical inner surface snugly surrounding the outer surface of the injection channel.

16. The injection molding machine according to claim 12, wherein the injection channel propagates through both the first mold plate and second mold plate.
